(19) United States
(12) Patent Application Publication
(10) Pub. No.: US 2025/0145791 A1
(43) Pub. Date: May 8, 2025

(54) COMPOSITION AND CURED PRODUCT FORMED FROM THE SAME

(71) Applicant: SAMSUNG DISPLAY CO., LTD., Yongin-si (KR)

(72) Inventor: Aely OH, Yongin-si (KR)

(21) Appl. No.: 18/829,617

(22) Filed: Sep. 10, 2024

(30) Foreign Application Priority Data
Nov. 2, 2023 (KR) 10-2023-0150276

(51) Int. Cl. C08K 5/01; C08F 220/18; C08K 3/04

(52) U.S. Cl. CPC C08K 5/01; C08F 220/1811; C08K 3/04; C08F 2800/20

(57) ABSTRACT

Provided is a composition including a wavelength conversion compound that absorbs a wavelength A and emits a wavelength B different from the wavelength A, a crosslinkable monomer, a polymerization monomer, a filler, and a photoinitiator.

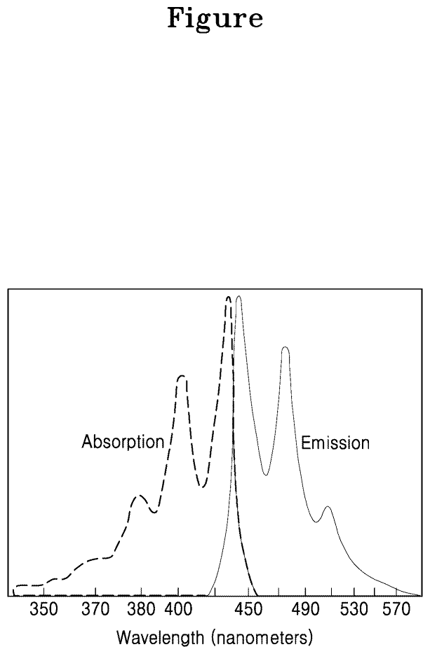

### CROSS-REFERENCE TO RELATED APPLICATION

This application claims priority to Korean Patent Application No. 10-2023-0150276, filed in the Korean Intellectual Property Office on Nov. 2, 2023, and all the benefits accruing therefrom under 35 U.S.C. § 119, the content of which in its entirety is herein incorporated by reference.

### BACKGROUND

### 1. Field

One or more embodiments relate to a composition and a cured product formed therefrom.

### 2. Description of the Related Art

A cured product to block ambient light is produced by ultraviolet (UV) light curing a composition, and may have a high optical density value.

Meanwhile, when it comes to compositions involving fillers, it is difficult to achieve a satisfactory cure depth because the fillers absorb UV light.

Considering the amount of process time, it is desirable to obtain a cured product having a high optical density and a satisfactory curing depth by performing curing for a short time.

### SUMMARY

One or more embodiments include a composition for forming a cured product having a satisfactory curing depth and a satisfactory optical density and a cured product formed therefrom.

Additional aspects will be set forth in part in the description which follows and, in part, will be apparent from the description, or may be learned by practice of the presented embodiments of the disclosure.

According to one or more embodiments, a composition includes a wavelength conversion compound that absorbs a wavelength A and emits a wavelength B different from the wavelength A, a crosslinkable monomer, and a photoinitiator.

According to one or more embodiments, provided is a cured product formed by curing the composition using ultraviolet light.

### BRIEF DESCRIPTION OF THE DRAWING

The above and other aspects, features, and advantages of certain embodiments of the disclosure will be more apparent from the following description taken in conjunction with

The FIGURE is a diagram that schematically depicts the absorption and emission spectra of a wavelength conversion compound, which absorbs a wavelength A and emits a wavelength B different from the wavelength A, included in a composition according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to The FIGURE, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

In order to block ambient light, the optical density of a cured product needs to be 2 or more (for example, @30 μm).

To increase optical density, a curing depth of 200 μm or more is desirable.

The cured product may be produced by curing a composition with UV light, which may include a filler to achieve a satisfactory level of optical density and block light. However, because the filler absorbs UV, it is difficult to obtain a satisfactory curing depth.

Additionally, considering a process time, a cured product formed by curing for a short time (for example, 2 seconds or less) needs to have a curing depth of 200 μm or more and an optical density (for example, @30 μm) value of 2 or more.

The composition according to one aspect may include a wavelength conversion compound that absorbs UV light at a wavelength A and emits light at a wavelength B different from the wavelength A, a crosslinkable monomer, a polymerization monomer, a filler, and a photoinitiator.

According to an embodiment, the length of the wavelength B may be longer than the length of the wavelength A. For example, the wavelength A may be a wavelength in an ultraviolet light region, and the wavelength B may be a wavelength in a visible light region. For example, the wavelength conversion compound may include a compound that absorbs light with wavelength A of about 250 nm to about 470 nm and emits light with wavelength A of about 380 nm to about 700 nm.

According to an embodiment, the wavelength conversion compound includes perylene, CdS, CdSe, CdTe, ZnS, perovskite, a complex of Tb(III) and pyridine-2,6-dipicolinic acid, a complex of Eu(III) and pyridine-2,6-dipicolinic acid, or a combination thereof. For example, the wavelength conversion compounds include perylene, CdS, CdSe, CdSe/CdS, CdSe/CdS/CdTe, CdSe/ZnS, perovskite, a complex of Tb(III) and pyridine-2,6-dipicolinic acid, a complex of Eu(III) and pyridine-2,6-dipicolinic acid, or a combination thereof.

The FIGURE is a diagram schematically showing the absorption and emission spectra of perylene included in a composition according to an embodiment. Referring to the FIGURE, it can be seen that perylene absorbs light in a ultraviolet light region and emits light in a visible light region.

The complex of Tb(III) and pyridine-2,6-dipicolinic acid may absorb light having the wavelength of 254 nm and emit light having the wavelength of about 492 nm to about 622 nm. The complex of Eu(III) and pyridine-2,6-dipicolinic acid may absorb light having the wavelength of 254 nm and emit light having the wavelength of about 594 nm to about 695 nm.

According to an embodiment, the crosslinkable monomer and the polymerization monomer may each independently include an acrylic monomer, a diisocyanate monomer, or a combination thereof.

According to an embodiment, the acryl-based monomer may include a C₁-C₂₀ alkyl group, a C₃-C₁₀ cycloalkyl group, —NCO, —OH, or a combination thereof.

According to an embodiment, the crosslinkable monomer may include an ultraviolet-light crosslinkable monomer, a visible-light crosslinkable monomer, a crosslinkable monomer that is crosslinkable at a low temperature, or a combination thereof. For example, the low temperature may be a temperature of about 25° C. to about 80° C.

According to an embodiment, the crosslinkable monomer may include isobornyl acrylate, acrylic acid, methyl acrylate, ethyl acrylate, isopropyl acrylate, n-butyl(meth)acrylate, isobutyl acrylate, tert-butyl acrylate, n-pentyl acrylate, n-hexyl acrylate, cyclohexyl acrylate, n-heptyl acrylate, n-octyl acrylate, 2-ethylhexyl acrylate, nonyl acrylate, decyl acrylate, or a combination thereof.

According to an embodiment, the polymerization monomer may include 2-isocyanatoethyl acrylate, 2,4-toluene diisocyanate, isophorone diisocyanate, hexamethylene diisocyanate, methylene diphenyl diisocyanate, 2-hydroxyethyl methacrylate, glycol methacrylate, glycol monomethacrylate, ethylene glycol methacrylate, 2-(methacryloyloxy)ethanol, or a combination thereof.

According to an embodiment, the photoinitiator may include a single initiator that reacts to each of ultraviolet light and visible light. In this regard, the photoinitiator refers to a compound in which not only radicals generated by decomposition by visible light can initiate the polymerization reaction of monomers, but also radicals generated by decomposition by ultraviolet light can initiate the polymerization reaction of monomers.

According to an embodiment, the photoinitiator may include an ultraviolet-light initiator and a visible-light initiator.

According to an embodiment, the photoinitiator may include Irgacure 784 (Irgacure 784 comprises 1-hydroxycyclohexyl phenyl ketone), Irgacure 819 (Irgacure 819 comprises 2-hydroxy-2-methyl-1-phenyl-propan-1-one), Irgacure 651 (Irgacure 651 comprises benzoin methyl ether), Irgacure 184 (Irgacure 184 comprises 1-hydroxycyclohexyl phenyl ketone), [ethoxy(phenyl)phosphoryl]-(2,4,6-trimethylphenyl)methanone (TPO-L), or a combination thereof.

Irgacure 784, Irgacure 819, Irgacure 651, and Irgacure 184 are product names for commercially available compounds.

For example, Irgacure 784 can be decomposed by ultraviolet light to generate radicals to initiate the polymerization reaction of monomers, and can also be decomposed by visible light to generate radicals to initiate the polymerization reaction of monomers.

For example, the wavelength of visible light is longer than the wavelength of ultraviolet light. Accordingly, when ultraviolet light is irradiated to the composition according to an embodiment, the wavelength conversion compound absorbs ultraviolet light and emits visible light. The visible light of a longer wavelength can reach deeper and decompose additional initiator (e.g., Irgacure 784) to generate radicals, thereby initiating the polymerization reaction of monomers.

Therefore, when the composition according to an embodiment is crosslinked with ultraviolet light, the curing depth is relatively deep and the optical density is increased.

In some embodiments, since the crosslinkable monomer in the composition according to an embodiment, has a reactive functional group (for example, a double bond), the crosslinkable monomer can be directly crosslinked by ultraviolet light or visible light, and radicals, generated by decomposition of the initiator that absorbs ultraviolet light at a relatively lower depth (for example, the depth that ultraviolet light can reach), may initiate the polymerization reaction of monomers. For example, isobornyl acrylate is a monomer that can undergo a curing reaction directly by visible light without an initiator.

According to an embodiment, the composition may further include a thermocatalyst. The term “thermocatalyst” as used herein may refer to a compound that catalyzes a polymerization reaction (for example, a polymerization reaction that creates a urethane bond) by heat generated in the reaction.

According to an embodiment, the thermocatalyst may include dibutyltin dilaurate, tin tetrachloride, butyltin trichloride, diorganotin ester, and dibutyltin oxide, or a combination thereof.

When the composition according to an embodiment further includes a thermocatalyst and the composition is irradiated using ultraviolet light, the thermocatalyst catalyzes a polymerization reaction (for example, a polymerization reaction that produces a urethane bond) by the heat generated in the polymerization reaction described above. Therefore, a wider range of curing may occur for a shorter time period, the curing depth may be relatively deeper and the curing density may be further increased.

For example, the thermocatalyst may catalyze polymerization reactions (for example, polymerization reactions that produce urethane bonds) of low-temperature polymerization monomers (for example, 2-isocyanatoethyl acrylate and 2-hydroxyethyl methacrylate) at temperatures of 80° C. or less.

According to an embodiment, the composition may further include a filler. For example, the filler may include carbon black, tungsten oxide, lanthanum oxide, titanium oxide, cobalt, graphite, graphene oxide, or a combination thereof.

Meanwhile, the carbon black may not be perylene black. Perylene black is a pigment and is not suitable for use as the filler.

According to an embodiment, the content of the wavelength conversion compound may be about 0.1 wt % to about 2 wt % and the content of the photoinitiator may be about 5 wt % to about 20 wt %, based on 100 wt % of the total weight of the composition.

When the content of the wavelength conversion compound exceeds 2 wt %, the wavelength conversion compound may act as fine particles and inhibit curing. When the content of the wavelength conversion compound is less than 0.1 wt %, the curing depth and optical density of the formed cured product may be unsatisfactory.

The content of the photoinitiator may be 5 wt % or more, and in this case, the photoinitiator may function as an initiator by visible light. When the content of the photoinitiator exceeds 20 wt %, the physical properties of the formed cured product may be poor. Meanwhile, when the photoinitiator includes an ultraviolet-light initiator and a visible-light initiator, the content of the photoinitiator may refer to the total content of the ultraviolet-light initiator and the visible-light initiator. In this regard, the weight ratio of the ultraviolet-light initiator and the visible-light initiator may be 9:1 to 1:9. For example, the weight ratio of the ultraviolet-light initiator and the visible-light initiator may be 6:4 to 4:6.

For example, the content of the thermocatalyst may be about 0.05 wt % to about 1 wt % based on 100 wt % of the total weight of the composition. Within the content range, the curing depth and optical density of the cured product are satisfactory.

For example, the content of the filler may be about 3 wt % to about 7 wt % based on 100 wt % of the total weight of the composition. The physical properties (for example, strength) of the cured product formed in this content range are satisfactory.

For example, the crosslinkable monomer may further include other monomers in addition to the monomer. For example, the crosslinkable monomer may further include N,N-dimethylacrylamide.

For example, the composition may further include an oligomer. For example, the composition may further include polypropylene glycol.

For example, the composition may include other additives. For example, the composition may include trace amounts of an antioxidant. For example, the composition may contain a trace amount of 2,6-bis(1,1-dimethylethyl)-4-methylphenol.

For example, the remainder of the content in the composition may be a crosslinkable monomer or a polymerization monomer.

The cured product according to another aspect may be formed by curing the composition with ultraviolet light.

For example, the cured product according to an embodiment may be formed by curing the composition with ultraviolet light for about 0.1 seconds to about 3 seconds. For example, the cured product according to an embodiment may be formed by curing the composition with ultraviolet light for about 0.5 seconds to about 2 seconds.

According to an embodiment, the curing depth of the cured product may be 200 μm or more.

According to an embodiment, the cured material may have an optical density value of 2 or more, at a thickness of 50 μm or less. For example, the cured product may have an optical density of 2 to 7 at a thickness of 30 μm.

Optical density, often abbreviated as OD, refers to a measure of how much light is absorbed or transmitted by a substance. It is commonly used in various fields such as chemistry, physics, biology, and environmental science.

Optical density is calculated using the formula:

$$OD = {log}_{10} ( {I}_{0} / I )$$

where:
OD is the optical density; I₀ is the intensity of incident light; and I is the intensity of transmitted light. The higher the optical density value, the more light is absorbed by the substance, and the less light is transmitted through it. Conversely, a lower optical density indicates less absorption and more transmission of light.

### Definition of Terms

The term “C₁-C₂₀ alkyl group” as used herein refers to a linear or branched aliphatic hydrocarbon monovalent group having 1 to 20 carbon atoms, and specific examples thereof include a methyl group, an ethyl group, a n-propyl group, an isopropyl group, a n-butyl group, a sec-butyl group, an isobutyl group, a tert-butyl group, a n-pentyl group, a tert-pentyl group, a neopentyl group, an isopentyl group, a sec-pentyl group, a 3-pentyl group, a sec-isopentyl group, a n-hexyl group, an isohexyl group, a sec-hexyl group, a tert-hexyl group, a n-heptyl group, an isoheptyl group, a sec-heptyl group, a tert-heptyl group, a n-octyl group, an isooctyl group, a sec-octyl group, a tert-octyl group, a n-nonyl group, an isononyl group, a sec-nonyl group, a tert-nonyl group, a n-decyl group, an isodecyl group, a sec-decyl group, a tert-decyl group, etc.

The term “a C₃-C₁₀ cycloalkyl group as used herein refers to a monovalent saturated hydrocarbon cyclic group having 3 to 10 carbon atoms, and specific examples thereof include a cyclopropyl group, a cyclobutyl group, a cyclopentyl group, a cyclohexyl group, a cycloheptyl group, a cyclooctyl group, a adamantanyl group, a norbonyl group (or a bicyclo[2.2.1]heptyl group), a bicyclo[1.1.1]pentyl group, a bicyclo[2.1.1]hexyl group, and a bicyclo[2.2.2]octyl group.

The number of carbon atoms referred to when substituents are defined, is an example.

Spatially relative terms such as “below,” “beneath,” “lower,” “above,” “upper,” etc. are used to easily describe the correlation between a single term or element and other terms or elements, as shown in the drawing. Spatially relative terms should be understood as terms that include different directions of an element during use or operation in addition to the direction shown in the drawings. For example, when an element shown in the drawings is turned over, an element described as “below” or “beneath” another element may be placed “above” the other element. Accordingly, the illustrative term “down” may include both downward and upward directions. Elements can also be oriented in other directions, so spatially relative terms can be interpreted according to orientation.

Hereinafter, a composition according to an embodiment will be described in more detail through examples.

### EXAMPLES

### Composition Preparation

### Example 1

This example demonstrates the manufacturing of the composition. A composition was prepared by mixing 1 wt % perylene, 10 wt % Irgacure 784, 0.07 wt % dibutyltin dilaurate, 6.5 wt % carbon black, 6 wt % 2-isocyanatoethyl acrylate, 6 wt % 2-hydroxyethyl methacrylate, and the remainder isobornyl acrylate.

### Example 2

A composition was prepared in the same manner as in Example 1 except for the inclusion of 8 wt % carbon black.

### Comparative Example 1

A composition was prepared in the same manner as in Example 1, except that perylene was not mixed.

The compositions prepared in Examples and Comparative Example were each applied on a substrate to a thickness of 300 μm and then exposed to irradiation of ultraviolet light of 365 nm for 2 seconds. The curing depth of each cured product was measured. Results are shown in Table 1.

In addition, the optical density of each cured product formed under these conditions was measured, except that the compositions prepared in Examples and Comparative Example were applied on the substrate to a thickness of 30 μm. Results are shown in Table 1.

The curing depth was determined as follows: an uncured part was removed after manufacture of a sample, and the back of the cured surface was measured using Fourier-transform infrared spectroscopy (FT-IR) (Bruker, ALPHA2 model), and a thickness at the curing rate of more than 90% was measured. The optical density was calculated using Equation 1 below by measuring the transmittance between 400 nm and 700 nm using a spectrometer (Dongil Shimazu Co., Ltd., UV-2600 model).

TABLE 1

| | Curing depth | |
|---|---|---|
| | (μm) | Optical density |
| Example 1 | 290 | 2.2 |
| Example 2 | 210 | 3.0 |
| Comparative | 70 | 1.9 |
| Example 1 | | |

$$Optical Density = - log T \qquad [ Equation 1 ]$$

$$\% T = 100 \times T ,$$

Where T is the transmissivity.

According to an embodiment, a composition comprises a light-down conversion compound, a crosslinkable monomer, a polymerization monomer, a filler, photoinitiator, and a thermocatalyst, and a short time process [a short cure time]product of the composition was identified to have a curing depth of 200 μm or more and, at a thickness of 30 μm, an optical density of 2 or more. The light-down conversion compound means the compound that absorbs a short wavelength light (energy) and emits a long wavelength light (energy). According to an embodiment, the light-down conversion compound may be a perylene.

A cured product that is obtained by ultraviolet-light curing using the composition according to an embodiment, has a deep curing depth and high optical density.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the FIG.s, it will be understood by those of ordinary skill in the art that various changes in form and details may be made therein without departing from the spirit and scope as defined by the following claims.

What is claimed is:

1. A composition comprising: a wavelength conversion compound that absorbs a wavelength A and emits a wavelength B different from the wavelength A; a crosslinkable monomer; a polymerization monomer; a filler; and a photoinitiator.

2. The composition of claim 1, wherein a length of the wavelength B is longer than a length of the wavelength A.

3. The composition of claim 1, wherein the wavelength A is a wavelength in an ultraviolet light region, and the wavelength B is a wavelength in a visible light region.

4. The composition of claim 1, wherein the wavelength conversion compound includes perylene, CdS, CdSe, CdTe, ZnS, perovskite, a complex of Tb(III) and pyridine-2,6-dipicolinic acid, a complex of Eu(III) and pyridine-2,6-dipicolinic acid, or a combination thereof.

5. The composition of claim 1, wherein the crosslinkable monomer and the polymerization monomer each independently include an acryl-based monomer, a diisocyanate-based monomer, or a combination thereof.

6. The composition of claim 5, wherein the acryl-based monomer includes a C₁-C₂₀ alkyl group, a C₃-C₁₀ cycloalkyl group, —NCO, —OH, or a combination thereof.

7. The composition of claim 1, wherein the crosslinkable monomer comprises an ultraviolet-light crosslinkable monomer, a visible-light crosslinkable monomer, a crosslinkable monomer that is crosslinkable at a low temperature, or a combination thereof.

8. The composition of claim 7, wherein the low temperature is a temperature of 80° C. or lower.

9. The composition of claim 1, wherein
the crosslinkable monomer comprises isobornyl acrylate, acrylic acid, methyl acrylate, ethyl acrylate, isopropyl acrylate, n-butyl(meth)acrylate, isobutyl acrylate, tert-butyl acrylate, n-pentyl acrylate, n-hexyl acrylate, cyclohexyl acrylate, n-heptyl acrylate, n-octyl acrylate, 2-ethylhexyl acrylate, nonyl acrylate, decyl acrylate, or a combination thereof, and
the polymerization monomer comprises 2-isocyanatoethyl acrylate, 2,4-toluene diisocyanate, isophorone diisocyanate, hexamethylene diisocyanate, methylene diphenyl diisocyanate, 2-hydroxyethyl methacrylate, glycol methacrylate, glycol monomethacrylate, ethylene glycol methacrylate, 2-(methacryloyloxy)ethanol, or a combination thereof.

10. The composition of claim 1, wherein the photoinitiator comprises a single initiator that reacts to each of ultraviolet light and visible light.

11. The composition of claim 1, wherein the photoinitiator comprises an ultraviolet-light initiator and a visible-light initiator.

12. The composition of claim 1, wherein the photoinitiator comprises 1-hydroxycyclohexyl phenyl ketone, 2-hydroxy-2-methyl-1-phenyl-propan-1-one, benzoin methyl ether, 1-hydroxycyclohexyl phenyl ketone, [ethoxy(phenyl)phosphoryl]-(2,4,6-trimethylphenyl)methanone (TPO-L), or a combination thereof.

13. The composition of claim 1, further comprising a thermocatalyst.

14. The composition of claim 13, wherein the thermocatalyst comprises dibutyltin dilaurate, tin tetrachloride, butyltin trichloride, diorganotin ester, and dibutyltin oxide, or a combination thereof.

15. The composition of claim 1, wherein the filler comprises carbon black, tungsten oxide, lanthanum oxide, titanium oxide, cobalt, graphite, graphene oxide, or a combination thereof.

16. The composition of claim 1, wherein a content of the wavelength conversion compound is about 0.1 wt % to about 2 wt % and a content of the photoinitiator is about 5 wt % to about 20 wt %, based on 100 wt % of a total weight of the composition.

17. A cured product formed by photocuring the composition of claim 1.

18. The cured product of claim 17, wherein the cured product has a curing depth of 200 μm or more.

19. The cured product of claim 17, wherein the cured product has an optical density value of 2 or more, at a thickness of 50 μm or less.

20. A composition comprising:
a light-down conversion compound,
a crosslinkable monomer,
a polymerization monomer,
a filler,
a photoinitiator, and
a thermocatalyst, wherein a cured product of the composition has a curing depth of 200 μm or more and, at a thickness of 30 μm, an optical density of 2 or more.
